(19) United States
(12) Patent Application Publication
(10) Pub. No.: US 2022/0072535 A1
(43) Pub. Date: Mar. 10, 2022

(54) MICROFLUIDIC DEVICES

(71) Applicant: Hewlett-Packard Development Company, L.P., Spring, TX (US)

(72) Inventors: Viktor SHKOLNIKOV, Palo Alto, CA (US); Alexander GOVYADINOV, Corvallis, OR (US)

(73) Assignee: Hewlett-Packard Development Company, L.P., Spring, TX (US)

(21) Appl. No.: 17/415,839

(22) PCT Filed: Apr. 30, 2019
(86) PCT No.: PCT/US2019/029884

§ 371 Date: Jun. 18, 2021

(51) Int. Cl. B01L 3/00

(52) U.S. Cl. CPC B01L 3/502707; B01L 2300/0887; B01L 2200/16

(57) ABSTRACT

The present disclosure relates to a microfluidic device including a microfluidic substrate and dry reagent-containing polymer particles. The microfluidic substrate includes a microfluidic-retaining region within the microfluidic substrate that is fluidly coupled to multiple microfluidic channels. The dry reagent-containing polymer particles include reagent and a degradable polymer. The reagent is releasable from the degradable polymer when exposed to release fluid. The dry reagent-containing particles are retained within the microfluidic substrate at the microfluidic-retaining region in position to release reagent into the egress microfluidic channel upon flow of release fluid from the ingress microfluidic channel through the microfluidic-retaining region.

### BACKGROUND

Microfluidic devices can exploit chemical and physical properties of fluids on a microscale. These devices can be used for research, medical, and forensic applications, to name a few, to evaluate or analyze fluids using very small quantities of sample and/or reagent to interact with the sample than would otherwise be used with full-scale analysis devices or systems.

### BRIEF DESCRIPTION OF THE DRAWINGS

FIG. 1 graphically illustrates a schematic view of an example microfluidic device in accordance with the present disclosure;

FIG. 2 graphically illustrates a schematic view of an example microfluidic device in accordance with the present disclosure;

FIG. 3 graphically illustrates a schematic view of an example microfluidic device in accordance with the present disclosure;

FIG. 4 graphically illustrates a schematic view of an example microfluidic device in accordance with the present disclosure;

FIG. 5 graphically illustrates a schematic view of an example microfluidic device in accordance with the present disclosure;

FIG. 6 graphically illustrates a schematic view of an example microfluidic device in accordance with the present disclosure;

FIG. 7 graphically illustrates a schematic view of an example microfluidic device in accordance with the present disclosure;

FIG. 8 graphically illustrates a schematic view of an example microfluidic device in accordance with the present disclosure;

FIG. 9 graphically illustrates a schematic view of an example dry reagent-containing polymer particle in accordance with the present disclosure;

FIG. 10 graphically illustrates a schematic view of an example dry reagent-containing polymer particle in accordance with the present disclosure;

FIG. 11 graphically illustrates a schematic view of an example dry reagent-containing polymer particle in accordance with the present disclosure;

FIG. 12 graphically illustrates a schematic view of an example dry reagent-containing polymer particle in accordance with the present disclosure;

FIG. 13 graphically illustrates a cross-sectional view of an example microfluidic system in accordance with the present disclosure;

FIG. 14 graphically illustrates a cross-sectional view of an example microfluidic system in accordance with the present disclosure;

FIG. 15 graphically illustrates a cross-sectional view of an example microfluidic system in accordance with the present disclosure;

FIG. 16 graphically illustrates a cross-sectional view of an example microfluidic system in accordance with the present disclosure; and

FIG. 17 is a flow diagram illustrating an example method of manufacturing a microfluidic device in accordance with the present disclosure.

### DETAILED DESCRIPTION

Microfluidic devices can permit the analysis of a fluid sample on the micro-scale. These devices utilize smaller volumes of a fluid sample and reagents during the analysis then would otherwise be used for a full-scale analysis. In addition, microfluidic devices can also allow for parallel analysis thereby providing faster analysis of a fluid sample. For example, during sample analysis, a reagent can be delivered to interact with the sample fluid. A reagent can be used to removal chemicals that interfere with sensing and/or to aid in sensing. Introducing the reagent during sample analysis can increase the cost and skill associated with the analysis, the time associated with conducting sample analysis, and the potential for error. Further, some reagents can be susceptible to environmental degradation and/or can be hydrolyzed upon exposure to moisture, and some reagents that are not thermally stable can be degraded upon exposure to heat. As such, reagents that are protected from environmental degradation can provide benefits.

In accordance with an example of the present disclosure, a microfluidic device includes a microfluidic substrate and dry reagent-containing polymer particles. The microfluidic substrate includes a microfluidic-retaining region that is fluidly coupled to multiple microfluidic channels. The dry reagent-containing polymer particles include reagent and a degradable polymer. The reagent is releasable from the degradable polymer when exposed to a release fluid. The dry reagent-containing polymer particles are retained within the microfluidic substrate at the microfluidic-retaining region in a position to release reagent into an egress microfluidic channel upon flow of the release fluid from an ingress microfluidic channel through the microfluidic-retaining region. In one example, the degradable polymer encapsulates partially or fully encapsulates the reagent forming a polymer-encapsulated reagent which includes a polymer shell and a reagent-containing core. In another example, the polymer shell further includes a second reagent admixed with the degradable polymer that is different than the reagent of the reagent-containing core. The second reagent can be positioned in the degradable polymer to be released prior to the reagent from the reagent-containing core. In yet another example, a second polymer shell encapsulates the degradable polymer. In a further example, the degradable polymer and the reagent are homogenously admixed together and then particlized to form particles of polymer matrix with reagent dispersed therein. In one example, the dry reagent-containing polymer particles have a D50 particle size from 100 nm to 10 μm, and the reagent of the dry reagent-containing polymer particles has a D50 particle size from 1 μm to 500 μm. In another example, the degradable polymer has a weight average molecular weight ranging from about 10 kDa to about 500 kDa. In yet another example, the degradable polymer includes polylactic acid, alkyne functionalized polylactic acid, biotinylated polylactic acid, polyvinyl alcohol, biotinylated polyvinyl alcohol, polyethylene glycol, biotinylated polyethylene glycol, polypropylene glycol, biotinylated polypropylene glycol, polytetramethylene glycol, biotinylated polytetramethylene glycol, polycarbolactone, biotinylated polycarbolactone, gelatene, biotinylated gelatene, copolymers thereof, or combinations thereof. In a further example, the degradable polymer includes biotin.

A microfluidic system is also disclosed and includes a microfluidic device with microfluidic substrate and a lid. The system also includes a reagent. A microfluidic-retaining region with an open channel is positioned within the microfluidic substrate. The lid is positionable over the microfluidic substrate to form an enclosed microfluidic-retaining region. The reagent is loadable in the microfluidic-retaining region to be enclosed by the lid. The enclosed microfluidic-retaining region is fluidly coupled to multiple microfluidic channels, e.g., defined by the microfluidic substrate and the lid, defined by the microfluidic substrate, or a combination thereof. In one example, the reagent is loaded in the open channel with a degradable polymer laminating the reagent therein. When the lid is positioned over the microfluidic substrate, an enclosed microfluidic channel is formed that is partially defined by the degradable polymer so that as a releasing fluid flows thereby, contact therewith contributes to release of the reagent from the degradable polymer. In one example, the system further includes a second reagent loaded at a second location within the enclosed microfluidic-retaining region that is laminated with a second degradable polymer. The second reagent differs from reagent, the second degradable polymer differs from the degradable polymer, or both the second reagent and the second degradable polymer differs from the reagent and the degradable polymer, respectively.

In another example, a method of manufacturing a microfluidic device includes loading dry reagent-containing polymer particles into a microfluidic-retaining region of a microfluidic substrate that is fluidly coupled to multiple microfluidic channels. The dry reagent-containing polymer particles include a reagent and a degradable polymer. The dry reagent-containing polymer particles are retained within the microfluidic substrate at the microfluidic-retaining region in a position to release the reagent into an egress microfluidic channel while exposed to a release fluid passed through the microfluidic-retaining region. In one example, the dry reagent-containing polymer particles includes polymer-encapsulated reagent, reagent dispersed in a polymer matrix, multi-layered polymer-encapsulated reagent, polymer-encapsulated reagent with the reagent dispersed in a polymer matrix, multi-layered polymer-encapsulated reagent with the reagent dispersed in polymer matrix, polymer-encapsulated reagent with reagent dispersed in a polymer shell of the polymer-encapsulated reagent, and combinations thereof. When there are multiple reagents or multiple degradable polymers or both, the multiple reagents or the multiple degradable polymers or both may be the same or different. In one example, the method includes dissolving reagent in a solvent to form a reagent-containing solution; admixing the reagent-containing solution with the degradable polymer to form a reagent-polymer solution; removing solvent from the reagent-polymer solution to form dry reagent-containing polymer; and particlizing the dry reagent-containing polymer to form a dry reagent-containing polymer particle, wherein the dry reagent-containing polymer particle has a D50 particle size from 1 μm to 500 μm.

When discussing the microfluidic device, the microfluidic system, or the method of method of manufacturing a microfluidic device herein, such discussions can be considered applicable to one another whether or not they are explicitly discussed in the context of that example. Thus, for example, when discussing a dry reagent-containing polymer particle in the context of a microfluidic device, such disclosure is also relevant to and directly supported in the context of the microfluidic system and/or the method of manufacturing a microfluidic device, and vice versa.

Terms used herein will be interpreted as the ordinary meaning in the relevant technical field unless specified otherwise. In some instances, there are terms defined more specifically throughout or included at the end of the present disclosure, and thus, these terms are supplemented as having a meaning described herein.

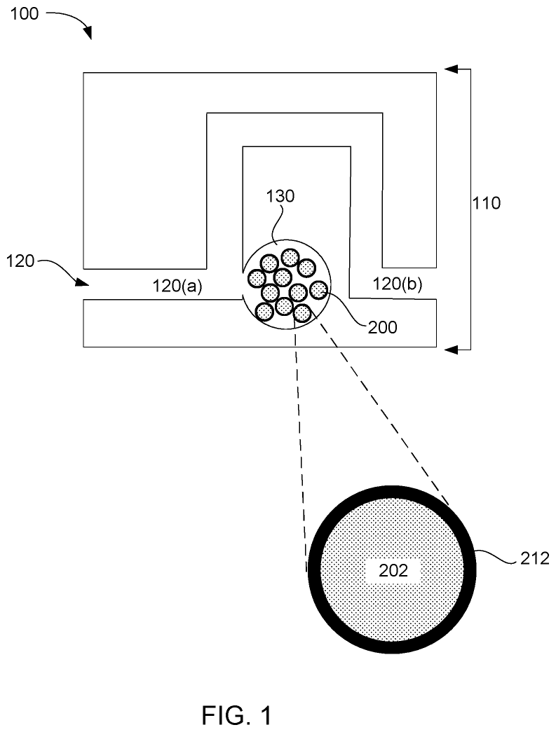

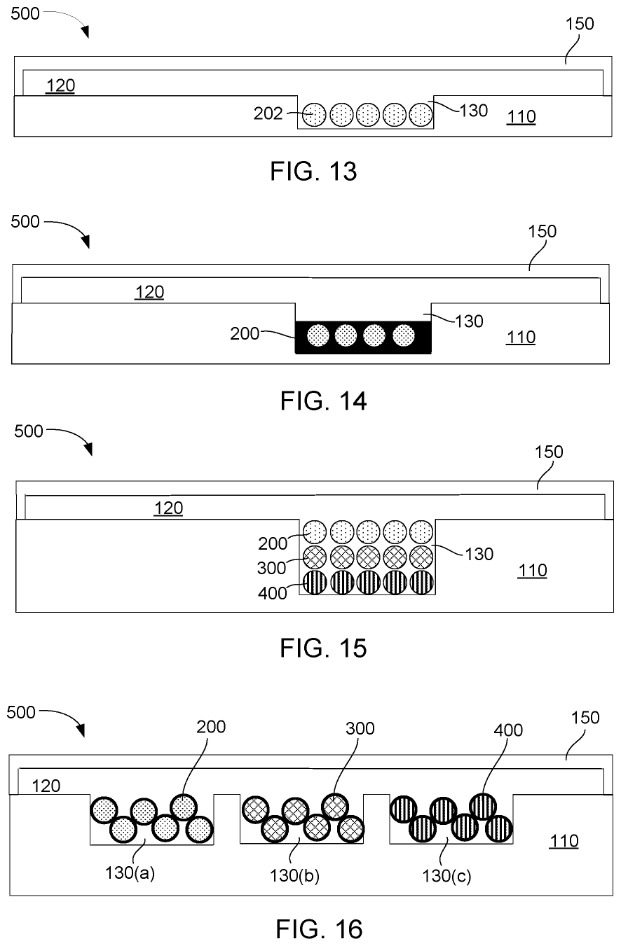

In accordance with the definitions and examples herein, FIGS. 1-8 depict various microfluidic devices and FIGS. 13-16 depict various microfluidic systems. These various examples can include various features, with several features common from example to example. Thus, the reference numerals used to refer to features depicted in FIGS. 1-8 and 13-16 are the same throughout to avoid redundancy, even though the microfluidic devices and the microfluidic systems can have structural differences, as shown.

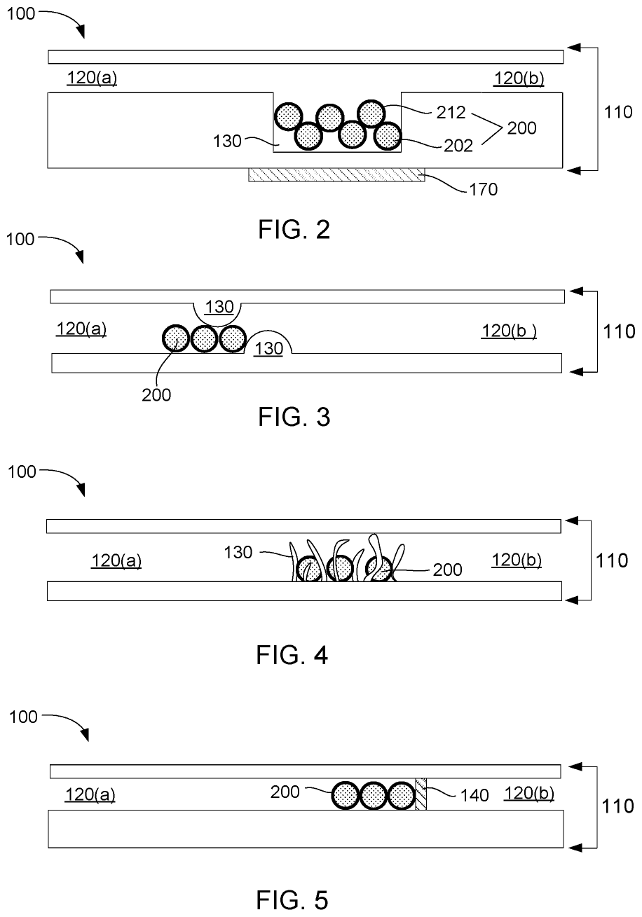

FIG. 1 depicts a schematic view of microfluidic device 100 that can include a microfluidic substrate 110 and a microfluidic-retaining region 130 that can be fluidly coupled to a microfluidic channel 120 (sometimes shown as 120(a) and 120(b) to show ingress opening and egress openings of the channel). Dry reagent-containing polymer particles 200 can be positioned in the microfluidic-retaining region and can include a reagent 202 and a degradable polymer 212. Notably, FIGS. 2-9 depict similar features that are commonly indicated with the same reference numerals as shown in FIG. 1, with a notable difference in the various structures of the respective microfluidic-retaining regions shown in those FIGS. Thus, these FIGS. are described herein together to some extent.

The term “dry reagent-containing particles” does not indicate that the particles are dry at every point in time, such as during manufacture of the particles or loading of the particles in the microfluidic device, for example. To illustrate, dry reagent-containing particles can be loaded (dispersed) in a carrier fluid to form a loading fluid (to load the particles at the microfluidic discontinuity feature and/or particle-retaining chemical coating that retains the particles. The carrier fluid may be removed, leaving the dry reagent-containing particles (even if some moisture inherently remains). Thus, the dry reagent-containing particles can likewise be defined as particulates that can be loaded at a location within the microfluidic device or system, and from which reagent can be release when exposed to a release fluid

Thus, in examples herein, reagent 202 can be releasable from degradable polymer 212 when release fluid (not shown, as it would typically be present during use) is flowed through the microfluidic channel 120 and thus fluidly communicates with the microfluidic-retaining region 130. As used herein a “release fluid” can refer to a fluid that can degrade, dissolve, or erode the degradable polymer or can carry the reagent upon degradation, dissolution, or erosion of the degradable polymer by other means, such as UV light, heat, or enzymes.

The microfluidic substrate 110 can be a single layer or multi-layer substrate. The material of the microfluidic substrate can include glass, silicon, polydimethylsiloxane (PDMS), polystyrene, polycarbonate, polymethyl methacrylate, poly-ethylene glycol diacrylate, perflouroaloxy, fluorinated ethylenepropylene, polyfluoropolyether diol methacrylate, polyurethane, cyclic olefin polymer, teflon, copolymers, and combinations thereof. In one example, the microfluidic substrate can include a hydrogel, ceramic, thermoset polyester, thermoplastic polymer, or a combination thereof. In another example, the microfluidic substrate can include silicon. In yet another example, the microfluidic substrate can include a low-temperature co-fired ceramic.

The microfluidic channel 120 can be negative space that can be etched, molded, or engraved from the material of the microfluidic substrate or can be formed by wall of different sections of a multi-layer microfluidic substrate. The microfluidic channel can include an ingress microfluidic channel 120(a) and an egress microfluidic channel 120(b) and can have a channel size that can range from 1 μm to 1 mm in diameter. In yet other examples, the microfluidic channel can have a channel size that can range from 1 μm to 500 μm, from 100 μm to 1 mm, from 250 μm to 750 μm, or from 300 μm to 900 μm, etc. The microfluidic channel can have a linear pathway, a curved path, a pathway with turns, a branched pathway, a serpentine pathway, or any other pathway configuration.

In one example, the microfluidic-retaining region 130 can include a microfluidic discontinuity feature. The microfluidic discontinuity feature can include a microfluidic cavity, microfluidic weir, microfluidic baleen, or a combination thereof. In one example, the microfluidic discontinuity feature can include a microfluidic cavity, such as that depicted schematically by example in FIGS. 1, 2, 7, and 8. In another example, the microfluidic discontinuity feature can include a microfluidic weir, such as that depicted by example in FIG. 3. In yet another example, the microfluidic discontinuity feature can include microfluidic baleen, such as that depicted schematically by example in FIG. 4. In some examples, the microfluidic discontinuity feature can include a combination of discontinuity features. The microfluidic discontinuity feature can be used to retain the dry reagent-containing polymer in the microfluidic-retaining region.

In some examples, as depicted in FIGS. 5 and 7 in particular, the microfluidic-retaining region 130 can be associated with a filtering element 140. The filtering element can be positioned downstream from the microfluidic-retaining region and can have an average opening that can permit air, release fluid, sample fluid, and released reagent in the presence of a loading fluid to flow there through while prohibiting the dry reagent-containing polymer particles 200 from flowing therethrough. The filtering element can be operable to prevent migration of the dry reagent-containing polymer particles after loading but before releasing reagent 202 therefrom. Accordingly, the filtering element can have an average opening that can be smaller than an average particle size of the dry reagent-containing polymer particles but larger than the average particle size of the reagent. In some examples, the filtering element can have an average opening ranging from 5 μm to 70 μm, from 5 μm to 7 μm, from 12 μm to 15 μm, from 50 μm to 70 μm, from 10 μm to 50 μm, or from 15 μm to 65 μm. The filtering element can include pillar, pillar array, chevron filter, porous membrane, or a combination thereof. In one example, the filtering element can include a porous membrane.

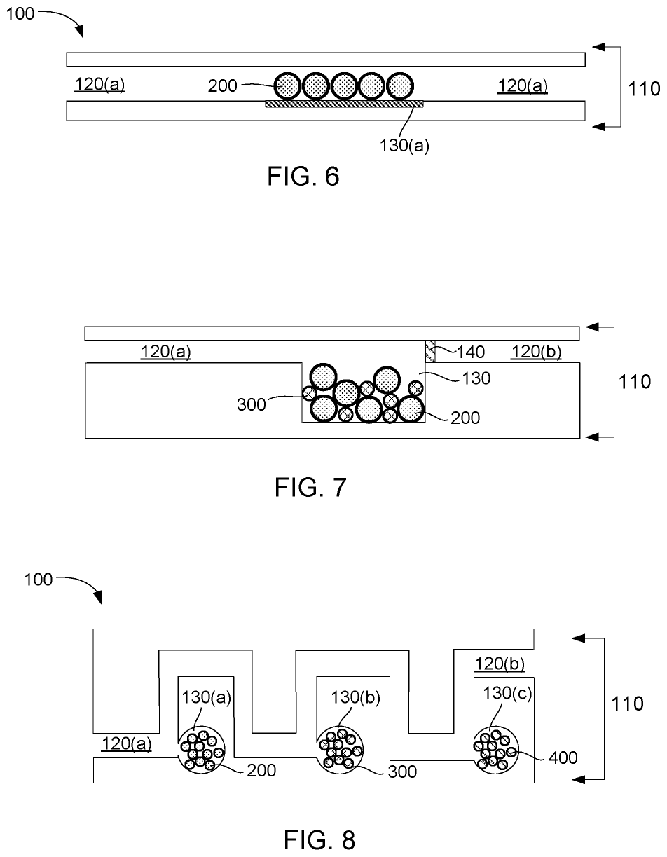

In yet other examples, the microfluidic-retaining region 130 can be in the form of a chemical coating, shown at 130(a) in FIG. 6 that can have an affinity to the degradable polymer 210 or a functional group attached to the degradable polymer of the dry reagent-containing polymer particles 200. For example, the chemical coating can include streptavidin and the degradable polymer can include biotin. In another example, the degradable polymer can include streptavidin and the degradable polymer can include avidin. Streptavidin forms a non-covalent bond with biotin and avidin. In yet another example, degradable polymer can include alkyne functionalized polylactic acid, and chemical coating can include azide functionalized polylactic acid. These functionalized groups undergo copper(I)-catalyzed azide-alkyne cycloaddition, forming a covalent bond. The chemical coating in some examples can be bound to a microfluidic channel wall surface of the microfluidic-retaining region as depicted in FIG. 6. In another example, the chemical coating can be bound to a microfluidic discontinuity feature such as a wall of a microfluidic cavity, a wall of a microfluidic weir, an exterior surface of the baleen or a wall of a microfluidic post, a filtering element, or any combinations thereof.

In some examples, the microfluidic device 100 can include a series of microfluidic cavities, such as that shown schematically by example in FIG. 8. The series of microfluidic cavities (130(a), 130(b), and 130(c) can be individually loaded with dry reagent-containing polymer particles. The microfluidic cavities can be loaded with the same dry reagent-containing polymer particles 200 or with multiple different types of dry reagent-containing polymer particles. For example, the microfluidic cavities can be loaded with the dry reagent-containing polymer particle, a second dry reagent-containing polymer particle 300, and a third dry reagent-containing polymer particle 400. Loading the microfluidic cavities with different types of dry reagent-containing polymer particles can permit a multi-step reaction.

In yet another example, the microfluidic device 100 can further include a configuration to assist in the release of the reagent 202 from the degradable polymer. For example, the microfluidic device can be transparent to ultra-violet light. In another example, the microfluidic device can include a thermal resistor 170 as shown in FIG. 2 by way of example but could be used in any of the examples shown or described herein. The thermal resistor, if present, can be associated with the microfluidic-retaining region to apply heat to degrade, erode, etc., the degradable polymer or otherwise release the reagent therefrom. In further detail, the thermal resistor can be positioned to thermally interact with the dry reagent-containing polymer particles 200. The thermal resistor can heat a degradable polymer that can be susceptible to heat thereby assisting in degradation of degradable polymer and the release of the reagent therefrom.

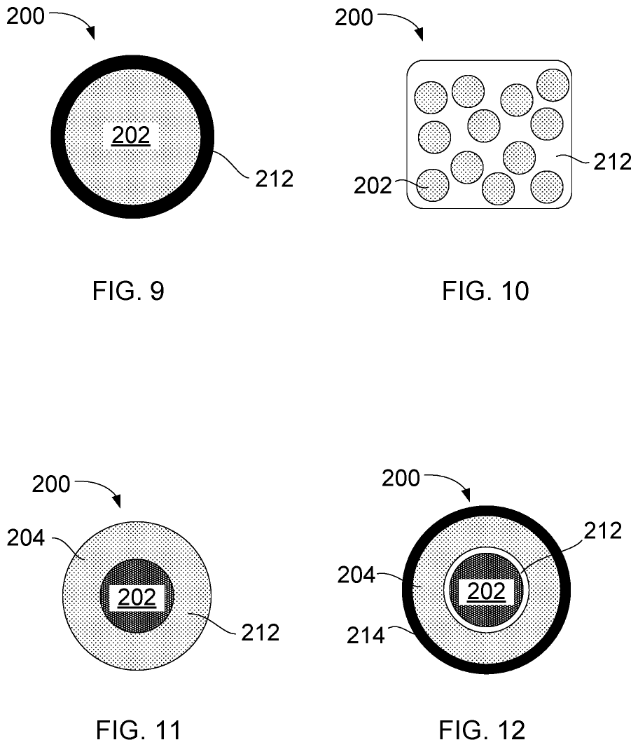

Irrespective of configuration, the microfluidic device 100 can include a dry reagent-containing polymer particle 200 positioned within the microfluidic-retaining region 130 of the device 100. The dry reagent-containing polymer particle can include a dry reagent 202 and a degradable polymer 212, as depicted in FIGS. 1-16. Though a general configuration of the dry reagent-containing polymer particles is shown in many of the FIGS. relative to the device, it is understood that there are many different types of arrangements where polymer and reagent can be combined for use in the devices shown. For example, the dry reagent-containing polymer particle can be in the form of a polymer-encapsulated reagent, reagent dispersed in a polymer matrix, multi-layered polymer-encapsulated reagent, polymer-encapsulated reagent with the reagent dispersed in a polymer matrix, multi-layered polymer-encapsulated reagent with the reagent dispersed in polymer matrix, polymer-encapsulated reagent with reagent dispersed in a polymer shell of the polymer-encapsulated reagent, etc., and/or combinations thereof. A shape of the dry reagent-containing polymer particle is not particularly limited. In some examples, the dry reagent-containing polymer particle can be spherical as depicted in FIGS. 1, 9, 11, and 12; cube-like as depicted in FIG. 10, rectangular as depicted in FIG. 14, or can have an irregular shape. The reference numerals shown in FIGS. 9-12 and 14 are likewise the similar to those described with respect to the FIGS. 1-8, and hereinafter with respect to FIGS. 13-16.

The size of the dry reagent-containing polymer particle 200 can also vary. For example, the dry reagent-containing polymer particle can have a D50 particle size that can range from 750 nm to 10 μm, from 1 μm to 8 μm, or from 1 μm to 5 μm. Individual particle sizes can be outside of these ranges, as the “D50 particle size” is defined as the particle size at which about half of the particles are larger than the D50 particle size and the about half of the other particles are smaller than the D50 particle size, by weight.

As used herein, particle size refers to the value of the diameter of spherical particles or in particles that are not spherical can refer to the longest dimension of that particle. The particle size can be presented as a Gaussian distribution or a Gaussian-like distribution (or normal or normal-like distribution). Gaussian-like distributions are distribution curves that may appear essentially Gaussian in their distribution curve shape, but which can be slightly skewed in one direction or the other (toward the smaller end or toward the larger end of the particle size distribution range). Particle size distribution values are not generally related to Gaussian distribution curves, but in one example of the present disclosure, the dry reagent-containing polymer particle can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” in distribution.

The reagent of the dry reagent-containing polymer particle can vary based on the intended use of the microfluidic device. For example, the reagent can include nucleic acid primers when conducting a chain reaction assay. In another example, the reagent can include secondary antibodies when conducting ELISA sandwich assays. In yet another example, a reagent can be a mixture of reagents. For example, a mixture of reagents could include a PCR mastermix. The PCR mastermix could include polymerases, magnesium salt, buffer, bovine serum albumin (BSA), primers, or combinations thereof. In further examples, a liquid reagent can be freeze-dried to obtain the reagent in particulate form. A particulate reagent can have a D50 particle size that can range from 500 nm to 500 μm, from 1 μm to 500 μm, from 25 μm to 250 μm, or from 100 μm to 300 μm.

The degradable polymer as used herein can refer to a polymer that degrades, erodes, or dissolves to release dry reagent upon reaction with a release fluid, heat, light, enzymes, or a combination thereof. In some examples, the degradable polymer can be used to prevent a premature reaction of the reagent. The degradable polymer can be un-inhibitive of the desired reaction between the dry reagent and the sample fluid. In one example, the degradable polymer can be inert with respect to the dry reagent and/or the sample fluid. The degradable polymer can be operable to release a dry reagent within a period of time ranging from one second to five minutes, from five seconds to two minutes, or from 30 seconds to three minutes.

The degradable polymer can have a weight average molecular weight that can range from about 10 kDa to about 500 kDa. In other examples, the degradable polymer can have a weight average molecular weight can range from 50 kDa to 300 kDa, from 25 kDa to 250 kDa, from 15 kDa to 450 kDa, or from 100 kDa to 400 kDa. In some examples, the degradable polymer can be water soluble. The degradable polymer can be selected from polylactic acid, alkyne functionalized polylactic acid, biotinylated polylactic acid, polyvinyl alcohol, biotinylated polyvinyl alcohol, polyethylene glycol, biotinylated polyethylene glycol, polypropylene glycol, biotinylated polypropylene glycol, polytetramethylene glycol, biotinylated polytetramethylene glycol, polycarbolactone, biotinylated polycarbolactone, gelatene, biotinylated gelatene, copolymers thereof, or combinations thereof. In one example, the degradable polymer can include biotin. A biotin containing degradable polymer can be used to adhere the dry reagent-containing polymer to the microfluidic-retaining region of the microfluidic substrate. For example, biotin can form a non-covalent bond to streptavidin coated on a surface.

In some examples, the degradable polymer can partially encapsulate or fully encapsulate the reagent to form a dry reagent-containing polymer particle. For example, the degradable polymer 212 can encapsulate the reagent 202 to form a spherical polymer shell and a reagent-containing core as depicted in FIG. 9. The reagent-containing core can include a single reagent particle or can include clumps of reagent.

In one example, the degradable polymer 212 and the reagent 202 can be homogenously admixed together and particlized to form particles of polymer matrix with reagent dispersed therein as depicted in FIG. 10. In another example, the dry reagent-containing polymer can include more than one reagent. For example, the degradable polymer shell can further include a second reagent 204. See FIG. 11. In yet another example, the second reagent can be admixed with the degradable polymer. The second reagent can coat the degradable polymer 212 and the dry-reagent-containing polymer particle can further include a second degradable polymer 214. See FIG. 12. The second reagent 204 can be different from the reagent 202 of the reagent containing core. The second degradable polymer can be different or the same as the degradable polymer. In still further examples, the dry reagent-containing polymer can include a second degradable polymer that can encapsulate the degradable polymer. The second degradable polymer can be used to control the release of the reagent from the degradable polymer.

Turning now specifically to certain microfluidic systems 500 described herein, FIGS. 13-16 provide several examples. In these FIGS., the microfluidic system can include a microfluidic substrate 110, a lid 150, and a reagent 202. The microfluidic substrate can include a microfluidic-retaining region 130 that can include an open channel positioned within the microfluidic system, e.g., defined in part by the substrate and the lid, but can also include channels into the substrate or other locations, for example. The microfluidic-retaining region can be fluidly coupled to the microfluidic channel(s) 120. These systems can also include microfluidic ingress and egress associated with the microfluidic channel. The lid can be positionable over the microfluidic substrate to form an enclosed microfluidic-retaining region, for example, the microfluidic channel(s). The reagent can be loadable in the microfluidic-retaining region to be enclosed by the lid. The microfluidic substrate, microfluidic retaining region, microfluidic channel, and reagent can be as described above.

In some examples, the reagent can be a dry reagent-containing polymer particle as described above. In yet other examples, the reagent can be loaded in the microfluidic-retaining region and the degradable polymer can be loaded in the microfluidic-retaining region afterwards such that the degradable polymer laminates the reagent therein, as depicted in FIG. 14. Then the lid can be positioned over the microfluidic substrate, forming an enclosed microfluidic channel. In some examples, the microfluidic-retaining region can be a cavity. In yet other examples, the microfluidic-retaining region can be a portion of an open microfluidic channel. The reagent and degradable polymer can be positioned in the microfluidic channel. As a releasing fluid flows thereby, contact with the degradable polymer contributes to release of reagent from the degradable polymer.

In one example, the microfluidic system can include additional reagents and additional degradable polymers. For example, the microfluidic system can include a second reagent and a second degradable polymer, a third reagent and a third degradable polymer, a fourth reagent and a fourth degradable polymer, and so on. In one example, the additional reagent and the additional degradable polymer can be retained within the same microfluidic retaining region, as depicted in FIG. 15. The additional reagent and additional degradable polymer are loaded in series so that a reagent can be released before a second reagent, and a second reagent can be released before a third reagent, and so forth. In yet other examples, the additional reagent can be retained within different microfluidic-retaining regions as shown in FIG. 16. For example, a second reagent can be loaded at a second location within the enclosed microfluidic-retaining region that can be laminated with a second degradable polymer. The second reagent can differ from the reagent, the second degradable polymer can differ from the degradable polymer, or both the second reagent and the second degradable polymer can differ from the reagent and the degradable polymer, respectively.

Regardless of the configuration, the microfluidic device and microfluidic system presented herein can be manufactured as part of a microfluidic chip. In one example, the microfluidic chip can be a lab on chip device. The lab on chip device can be a point of care system.

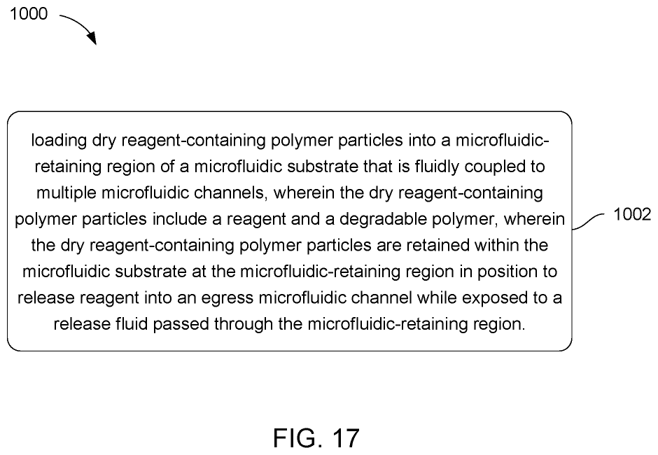

Further presented herein, is a method of manufacturing a microfluidic device 1000. See FIG. 17. In one example, the method can include loading 1002 dry reagent-containing polymer particles into a microfluidic-retaining region of a microfluidic substrate that can be fluidly coupled to multiple microfluidic channels. The dry reagent-containing polymer particles can include a reagent and a degradable polymer. The dry reagent-containing polymer particles can be retained within the microfluidic substrate at the microfluidic-retaining region in a position to release reagent into an egress microfluidic channel while exposed to a release fluid passed through the microfluidic-retaining region.

In one example, the dry reagent-containing polymer particles can include polymer-encapsulated reagent, reagent dispersed in a polymer matrix, multi-layered polymer-encapsulated reagent, polymer-encapsulated reagent with the reagent dispersed in a polymer matrix, multi-layered polymer-encapsulated reagent with the reagent dispersed in polymer matrix, polymer-encapsulated reagent with reagent dispersed in a polymer shell of the polymer-encapsulated reagent, and combinations thereof, wherein when there are multiple reagents or multiple polymers or both, the multiple reagents or multiple polymers or both may be the same or different. In some examples, the reagent can be a liquid phase and freeze-dried within the microfluidic retaining region to form a dry reagent. In yet other examples, the reagent can be loaded as part of a molten polymer/reagent mix.

In one example, loading the dry reagent-containing polymer particles can include, dissolving reagent in solvent to form a reagent-containing solution; admixing the reagent-containing solution with the degradable polymer to form a reagent-polymer solution; removing solvent from the reagent-polymer solution to form dry reagent-containing polymer; and particlizing the dry reagent-containing polymer to form dry reagent-containing polymer particle.

In another example, loading the dry reagent-containing polymer particles can include ejecting reagent through a sheet of molten degradable polymer. A surface tension of the degradable polymer can insure that the reagent can be encapsulated by the degradable polymer.

In a further example, loading the dry reagent-containing polymer particles can include admixing the reagent with molten degradable polymer to form a molten reagent-polymer admixture; extruding the admixture into a thin film; and particlizing the dry reagent-containing polymer to form dry reagent-containing polymer particle.

In yet a further example, loading the dry reagent-containing polymer particles can include sandwiching the reagent between films of degradable polymer; pressing the films with the reagent therebetween; and particlizing the dry reagent-containing polymer to form dry reagent-containing polymer particle. The pressing can include a vacuum press, rollers, or other pressuring means.

As used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on presentation in a common group without indications to the contrary.

Concentrations, dimensions, amounts, and other numerical data may be presented herein in a range format. A range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, a numeric range that ranges from about 10 to about 500 should be interpreted to include the explicitly recited sub-range of 10 to 500 as well as sub-ranges thereof such as about 50 and 300, as well as sub-ranges such as from 100 to 400, from 150 to 450, from 25 to 250, etc.

The terms, descriptions, and figures used herein are set forth by way of illustration and are not meant as limitations. Many variations are possible within the disclosure, which is intended to be defined by the following claims—and equivalents—in which all terms are meant in the broadest reasonable sense unless otherwise indicated.

What is claimed is:

1. A microfluidic device, comprising:
a microfluidic substrate, including a microfluidic-retaining region within the microfluidic substrate that is fluidly coupled to multiple microfluidic channels; and
dry reagent-containing polymer particles including reagent and a degradable polymer, wherein the reagent is releasable from the degradable polymer when exposed to release fluid, wherein the dry reagent-containing polymer particles are retained within the microfluidic substrate at the microfluidic-retaining region in position to release reagent into the egress microfluidic channel upon flow of release fluid from the ingress microfluidic channel through the microfluidic-retaining region.

2. The microfluidic device of claim 1, wherein the degradable polymer encapsulates partially or fully encapsulates the reagent forming a polymer-encapsulated reagent which includes a polymer shell and a reagent-containing core.

3. The microfluidic device of claim 2, wherein the polymer shell further includes a second reagent admixed with the degradable polymer that is different than the reagent of the reagent-containing core, wherein the second reagent is positioned in the degradable polymer to be released prior to the reagent from the reagent-containing core.

4. The microfluidic device of claim 3, further comprising a second polymer shell that encapsulates the polymer shell.

5. The microfluidic device of claim 1, wherein the degradable polymer and the reagent are homogenously admixed together and then particlized to form particles of polymer matrix with reagent dispersed therein.

6. The microfluidic device of claim 1, wherein the dry reagent-containing polymer particles have a D50 particle size from 100 nm to 10 μm, and the reagent of the dry reagent-containing polymer particles has a D50 particle size from 1 μm to 500 μm.

7. The microfluidic device of claim 1, wherein the degradable polymer has a weight average molecular weight ranging from about 10 kDa to about 500 kDa.

8. The microfluidic device of claim 1, wherein the degradable polymer includes polylactic acid, alkylene functionalized polylactic acid, biotinylated polylactic acid, polyvinyl alcohol, biotinylated polyvinyl alcohol, polyethylene glycol, biotinylated polyethylene glycol, polypropylene glycol, biotinylated polypropylene glycol, polytetramethylene glycol, biotinylated polytetramethylene glycol, polycarbolactone, biotinylated polycarbolactone, gelatene, biotinylated gelatene, copolymers thereof, or combinations thereof.

9. The microfluidic device of claim 1, wherein the degradable polymer includes biotin.

10. A microfluidic system, comprising:
a microfluidic device, including:
a microfluidic substrate, including a microfluidic-retaining region with an open channel positioned within the microfluidic substrate, and
a lid positionable over the microfluidic substrate to form an enclosed microfluidic-retaining region; and
a reagent loadable in the microfluidic-retaining region to be enclosed by the lid,
wherein the enclosed microfluidic-retaining region is fluidly coupled to multiple microfluidic channels.

11. The microfluidic system of claim 10, wherein the reagent is loaded in the open channel with a degradable polymer laminating the reagent therein, wherein when the lid is positioned over the microfluidic substrate, an enclosed microfluidic channel is formed that is partially defined by the degradable polymer so that as a releasing fluid flows thereby, contact therewith contributes to release of reagent from the degradable polymer.

12. The microfluidic system of claim 10, further comprising a second reagent loaded at a second location within the enclosed microfluidic-retaining region that is laminated with a second degradable polymer, wherein the second reagent differs from reagent, the second degradable polymer differs from the degradable polymer, or both the second reagent and the second degradable polymer differs from the reagent and the degradable polymer, respectively.

13. A method of manufacturing a microfluidic device, comprising loading dry reagent-containing polymer particles into a microfluidic-retaining region of a microfluidic substrate that is fluidly coupled to multiple microfluidic channels, wherein the dry reagent-containing polymer particles include a reagent and a degradable polymer, wherein the dry reagent-containing polymer particles are retained within the microfluidic substrate at the microfluidic-retaining region in position to release reagent into an egress microfluidic channel while exposed to a release fluid passed through the microfluidic-retaining region.

14. The method of manufacturing a microfluidic device of claim 13, wherein the dry reagent-containing polymer particles include polymer-encapsulated reagent, reagent dispersed in a polymer matrix, multi-layered polymer-encapsulated reagent, polymer-encapsulated reagent with the reagent dispersed in a polymer matrix, multi-layered polymer-encapsulated reagent with the reagent dispersed in polymer matrix, polymer-encapsulated reagent with reagent dispersed in a polymer shell of the polymer-encapsulated reagent, and combinations thereof.

15. The method of manufacturing a microfluidic device of claim 13, wherein loading includes:
dissolving reagent in solvent to form a reagent-containing solution;
admixing the reagent-containing solution with the degradable polymer to form a reagent-polymer solution;
removing solvent from the reagent-polymer solution to form dry reagent-containing polymer; and
particlizing the dry reagent-containing polymer to form dry reagent-containing polymer particle, wherein the dry reagent-containing polymer particle has a D50 particle size from 1 μm to 500 μm.
